(19) United States
(12) Patent Application Publication
(10) Pub. No.: US 2013/0149973 A1
(43) Pub. Date: Jun. 13, 2013

(54) RSSI SIGNAL ERROR-DETECTION PROTECTION CIRCUIT, RECEIVER AND REMOTE KEYLESS ENTRY SYSTEM

(71) Applicants: Takeshi MURASAKI, Kanagawa-ken (JP); Tsuneo SUZUKI, Kanagawa-ken (JP)

(72) Inventors: Takeshi MURASAKI, Kanagawa-ken (JP); Tsuneo SUZUKI, Kanagawa-ken (JP)

(73) Assignee: Kabushiki Kaisha Toshiba, Tokyo (JP)

(21) Appl. No.: 13/424,770

(22) Filed: Mar. 20, 2012

(30) Foreign Application Priority Data
Dec. 7, 2011 (JP) 2011-267569

(51) Int. Cl. H04B 1/16; H04B 7/24

(52) U.S. Cl. 455/68; 455/265

(57) ABSTRACT

According to one embodiment, an RSSI signal error-detection protection circuit configured with respect to an RSSI circuit outputting an RSSI signal on a basis of an output level of an amplifier amplifying intermediate frequency signal outputted from a mixer circuit includes an RSSI operation control unit configured to switch between operation and non-operation of the RSSI circuit by controlling the lock detection signal outputted from the PLL circuit configured to control a local oscillation frequency signal inputted from the mixer circuit.

### CROSS REFERENCE TO RELATED APPLICATION

This application is based upon and claims the benefit of priority from prior Japanese Patent Application No. 2011-267569, filed on Dec. 7, 2011, the entire contents of which are incorporated herein by reference.

### FIELD

Exemplary embodiments described herein generally relate to an RSSI signal error-detection protection circuit, a receiver and a remote keyless entry system.

### BACKGROUND

In a receiver or the like of a remote keyless entry system installed in a vehicle, for example, an RSSI (Reception Signal Strength Indicator) circuit is provided to detect reception field strength. In general, the RSSI circuit outputs an RSSI signal on the basis of an output level of a limiter amplifier configured to amplify an intermediate frequency signal outputted from a mixer circuit.

Some remote keyless entry systems are configured to perform communications while switching between a plurality of frequency channels to avoid interference caused by a noise and the like.

Meanwhile, a power supply of the receiver of the remote keyless entry system is a battery of the vehicle. For this reason, some remote keyless entry systems use an intermittent reception method in which the power supply of the receiver is turned ON/OFF periodically to suppress consumption of the battery while the vehicle is stopped.

In such a receiver configured to perform the reception channel switching or intermittent reception as described above, however, output of a PLL circuit configured to output a local oscillation frequency signal to the mixer circuit is unstable during start-up of the power supply in the case of reception channel switching or intermittent reception.

For this reason, there is a case where the level of the intermediate frequency signal outputted from the mixer circuit transiently increases. As a result of such increase, there arises a problem that the RSSI circuit outputs an RSSI signal indicating “presence of a desired signal” although the receiver is not in a normal reception state.

### BRIEF DESCRIPTION OF THE DRAWINGS

FIG. 1 is a block diagram showing a configuration example of an RSSI signal error-detection protection circuit and circuits around the RSSI signal error-detection protection circuit according to a first embodiment;

FIG. 2 is a circuit diagram showing an example of specific circuit configurations of the RSSI signal error-detection protection circuit and an RSSI circuit according to the first embodiment;

FIG. 3 is a waveform diagram showing an operation example of the RSSI signal error-detection protection circuit according to the first embodiment;

FIG. 4 is a circuit diagram showing a configuration example of an RSSI signal error-detection protection circuit according to a second embodiment;

FIG. 5 is a waveform diagram showing an operation example of the RSSI signal error-detection protection circuit according to the second embodiment;

FIG. 6 is a circuit diagram showing a configuration example of an RSSI signal error-detection protection circuit according to a third embodiment;

FIG. 7 is a circuit diagram showing a delay circuit of an RSSI signal error-detection protection circuit according to a fourth embodiment;

FIG. 8 is a diagram showing an example of an internal configuration of the delay circuit and an operation waveform of the delay circuit according to the fourth embodiment;

FIG. 9 is a block diagram showing a configuration example of a remote keyless entry system which is an application example of the RSSI signal error-detection protection circuit according to the first embodiment; and

FIG. 10 is a characteristic diagram showing a relation between an input power of a receiver and an output voltage of an RSSI signal.

### DETAILED DESCRIPTION

An aspect of the present embodiment, there is provided an RSSI signal error-detection protection circuit, including an RSSI signal error-detection protection circuit configured with respect to an RSSI circuit outputting an RSSI signal on a basis of an output level of an amplifier amplifying intermediate frequency signal outputted from a mixer circuit includes an RSSI operation control unit configured to switch between operation and non-operation of the RSSI circuit by controlling the lock detection signal outputted from the PLL circuit configured to control a local oscillation frequency signal inputted from the mixer circuit.

Another aspect of the present embodiment, there is provided a receiver including a mixer circuit, an amplifier amplifying intermediate frequency signal outputted from a mixer circuit, an RSSI circuit outputting an RSSI signal on a basis of the output level outputted from the amplifier, a PLL circuit configured to control a frequency of a local oscillation frequency inputted to the mixer circuit, and an RSSI signal error-detection protection circuit which includes an RSSI operation control unit configured to switch between operation and non-operation of the RSSI circuit by controlling the lock detection signal outputted from the PLL circuit.

Another aspect of the present embodiment, there is provided a remote keyless entry system, including a transmitter, and a receiver, the receiver being constituted with a radio frequency receiving integrated circuit, an MCU, and a SAW filter inputted a signal received by an antenna, the radio frequency receiving integrated circuit being constituted with a mixer circuit, an amplifier amplifying intermediate frequency signal outputted from a mixer circuit, an RSSI circuit outputting an RSSI signal on a basis of the output level outputted from the amplifier, a PLL circuit configured to control a frequency of a local oscillation frequency inputted from the mixer circuit, and an RSSI signal error-detection protection circuit which includes an RSSI operation control unit configured to switch between operation and non-operation of the RSSI circuit by controlling the lock detection signal outputted from the PLL circuit.

Embodiments will be described below with reference to the drawings. Note that, the same reference numerals are used to denote the same or corresponding portions throughout the drawings, and the descriptions of the same or corresponding portions will not be repeated.

### First Embodiment

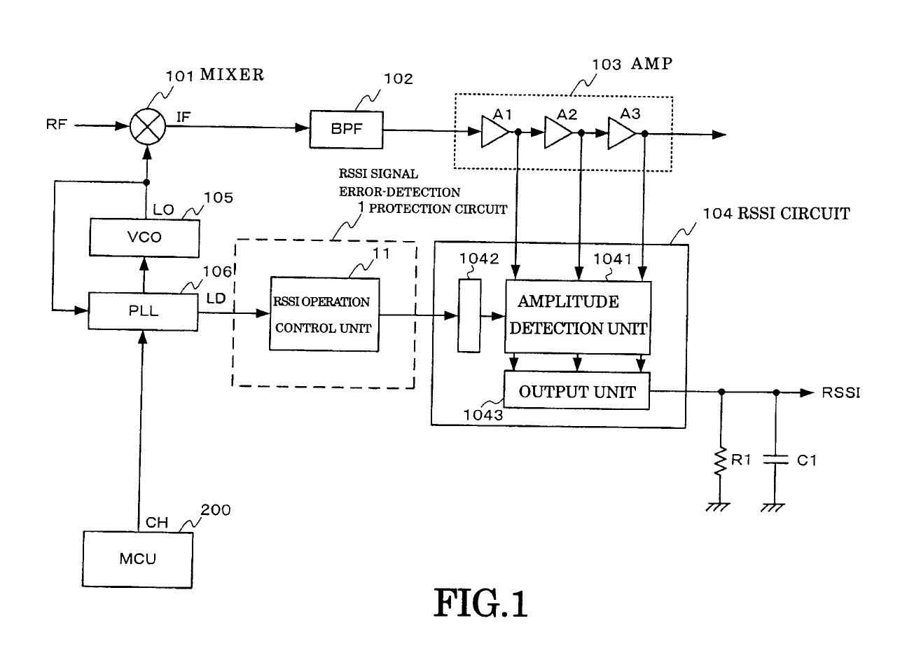

FIG. 1 is a block diagram showing a configuration example of a primary portion of a receiver in which an RSSI signal error-detection protection circuit 1 in a first embodiment is installed.

The receiver includes a mixer circuit 101, a BPF (band-pass filter) 102, a limiter amplifier 103, and an RSSI circuit 104. The mixer circuit 101 converts a received radio frequency (RF) signal into an intermediate frequency (IF) signal. The BPF 102 removes unnecessary frequency from the IF signal. The limiter amplifier 103 amplifies an output signal of the BPF 102. The RSSI circuit 104 outputs an RSSI signal indicating reception field strength on the basis of the limiter amplifier 103.

Here, the limiter amplifier 103 employs a multistage configuration. Thus, the output from an amplifier of each stage (A1, A2, A3, for example) is inputted to the RSSI circuit 104.

The RSSI circuit 104 includes an amplitude detection unit 1041, a current source 1042 for the amplitude detection unit 1041, and an output unit 1043. The amplitude detection unit 1041 converts the output amplitude of the amplifier of each stage of the limiter amplifier 103 into electrical current. The output unit 1043 adds together the currents outputted from the amplitude detection unit 1041 and outputs an RSSI current.

A resistance R1 and a capacitor C1 are connected to an output terminal of the RSSI circuit 104. The RSSI current outputted from the RSSI circuit 104 is subjected to current-voltage conversion by the resistance R1. Thus, the RSSI signal of voltage output can be obtained.

In addition, the receiver includes a VCO (Voltage-Controlled Oscillator) 105 and a PLL (Phase-Locked Loop) circuit 106. The VCO 105 generates a local oscillation frequency (LO) signal applied to the mixer circuit 101. The PLL circuit 106 controls the oscillation frequency of the VCO 105.

The PLL circuit 106 receives a reception channel (CH) instruction from an MCU 200 and switches the oscillation frequency of the VCO 105. During the switching process, the PLL circuit 106 is in an unlocked state until the oscillation frequency of the VCO 105 reaches to a desired frequency. When the oscillation frequency of the VCO 105 reaches to the desired frequency, the PLL circuit 106 is turned into a locked state.

Meanwhile, the PLL circuit 106 outputs a lock detection signal LD indicating whether the PLL circuit 106 is in a locked state or in an unlocked state. Here, the lock detection signal LD indicates “H (High level)” when the PLL circuit 106 is in a locked state and indicates “L (Low level)” when the PLL circuit 106 is in an unlocked state.

Moreover, in a case where the receiver uses the intermittent reception method, the PLL circuit 106 is in an unlocked state until the oscillation frequency of the VCO 105 becomes stable during start-up of the power supply.

To put it specifically, when the PLL circuit 106 is in an unlocked state, the receiver is in a state where the oscillation frequency of the VCO 105 is unstable. In this state, there is a case where the level of the IF signal outputted from the mixer circuit 101 increases, transiently. For this reason, the RSSI circuit 104 outputs an erroneous RSSI signal sometimes.

In this respect, the receiver includes the RSSI signal error-detection protection circuit 1 and prevents the RSSI circuit 104 from outputting an erroneous RSSI signal during start-up of the power supply in the case of reception channel switching or intermittent reception.

The RSSI signal error-detection protection circuit 1 of the first embodiment includes an RSSI operation control unit 11, which switches between operation and non-operation of the RSSI circuit 104 by controlling the lock detection signal LD outputted from the PLL circuit 106.

The RSSI operation control unit 11 causes the RSSI circuit 104 to operate when the lock detection signal LD indicates a locked state.

Meanwhile, the RSSI operation control unit 11 causes the RSSI circuit 104 to stop operation when the lock detection signal LD indicates an unlocked state. Accordingly, the level of the RSSI signal outputted from the RSSI circuit 104 is fixed to a “non-detection” level.

To put it specifically, the RSSI circuit 104 stops operation while the PLL circuit 106 is in an unlocked state, which is during start-up or the like of the power supply in the case of reception channel switching or intermittent reception. Thus, it is caused possible to prevent the RSSI circuit 104 from outputting an erroneous RSSI signal.

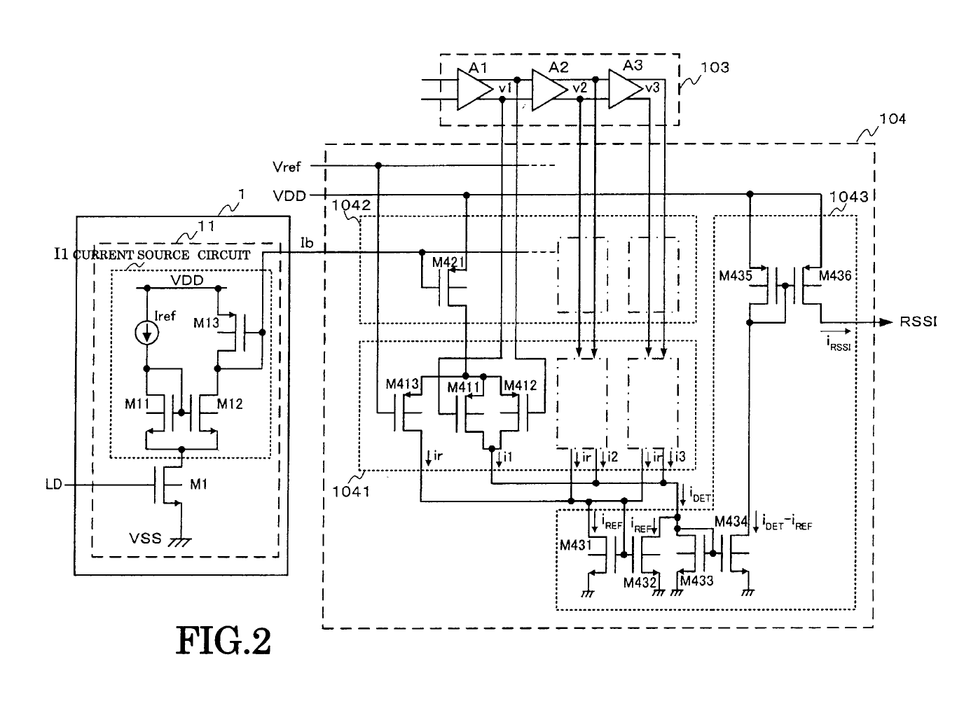

FIG. 2 shows an example of specific circuit configurations of the RSSI operation control unit 11 and the RSSI circuit 104. Here, the amplifiers forming the limiter amplifier 103 are each assumed to operate by a differential signal. Moreover, the configurations of the amplitude detection unit 1041 and the current source 1042 of the RSSI circuit 104 are partially shown for the output of the amplifier of the initial stage of the limiter amplifier 103 in FIG. 2, but the circuit having the same configurations as the circuit for the amplifier of the initial stage is connected to the output of each of the amplifiers of the second and later stages of the limiter amplifier 103.

The RSSI operation control unit 11 includes a current source circuit I1 and an n-ch MOS transistor M1. The current source circuit I1 generates an operation current for the RSSI circuit 104. The n-ch MOS transistor M1 functions as a switch. The n-ch MOS transistor M1 switches between the states to supply and not to supply a current outputted from the current source circuit I1 to the RSSI circuit 104 by controlling the lock detection signal LD.

The current source circuit I1 includes a reference current source Iref, an n-ch MOS transistor M11, an n-ch MOS transistor M12, and a p-ch MOS transistor M13. The n-ch MOS transistor M11 is connected to the reference current source Iref. The n-ch MOS transistor M12 forms a current mirror circuit with the n-ch MOS transistor M11. The mirror current outputted to the n-ch MOS transistor M12 flows through the p-ch MOS transistor M13. The n-ch MOS transistor M11 and the n-ch MOS transistor M12 are commonly connected to the n-ch MOS transistor M1.

When the lock detection signal LD inputted to the gate terminal of the n-ch MOS transistor M1 indicates “H”, a reference current Iref flows through the n-ch MOS transistor M11 from the reference current source Iref, and a current Ib is outputted to the RSSI circuit 104 from the p-ch MOS transistor M13.

Meanwhile, when the lock detection signal LD indicates “L”, no current flows through the n-ch MOS transistor M11, and no current is thus supplied to the RSSI circuit 104.

Next, an example of an internal configuration of the RSSI circuit 104 will be described.

The amplitude detection unit 1041 includes p-ch MOS transistors M411, M412, and a p-ch MOS transistor M413. A differential output v1 (v2, v3) of the amplifier A1 (A2, A3) among the plurality of amplifiers of the limiter amplifier 103 is inputted to the p-ch MOS transistors M411, M412. A reference voltage Vref is inputted to the p-ch MOS transistor M413.

The current source 1042 includes a p-ch MOS transistor M421, which forms a current mirror circuit with the p-ch MOS transistor M13 of the RSSI signal error-detection protection circuit 1.

Accordingly, when the lock detection signal LD indicates “H” and the current Ib is inputted from the RSSI signal error-detection protection circuit 1, an operation current is supplied from the p-ch MOS transistor M421 to the p-ch MOS transistors M411, M412, M413 of the amplitude detection unit 1041.

In such a manner, a current i1 (i2, i3) corresponding to the differential output v1 (v2, v3) of the amplifier A1 (A2, A3) of the limiter amplifier 103 is outputted from the p-ch MOS transistors M411, M412, and a current ir corresponding to the reference voltage Vref is outputted from the p-ch MOS transistor M413.

Here, a size ratio W/L, where W and L are set to be a gate width and a gate length of the p-ch MOS transistors M411, M412, M413, respectively, is set to be a proportion of 1:1:2, so that i1 (i2, i3) equals to ir when no IF signal is present.

The output unit 1043 includes an n-ch MOS transistor M431, an n-ch MOS transistor M432, an n-ch MOS transistor M433, and an n-ch MOS transistor M434. A current Iref which equal to sum of Ir, Ir, Ir, obtained by adding together currents ir outputted from the amplitude detection unit 1041 is inputted to the n-ch MOS transistor M431. The n-ch MOS transistor M432 forms a current mirror circuit of a mirror ratio equal to 1 with the n-ch MOS transistor M431. A current IDET which equals to a sum of i1, i2, i3 obtained by adding together the currents i1, i2, i3 outputted from the amplitude detection unit 1041 is inputted to the n-ch MOS transistor M433. The n-ch MOS transistor M434 forms a current mirror circuit of a mirror ratio equal to 1 with the n-ch MOS transistor M433.

Here, the drain terminal of the n-ch MOS transistor M432 and the drain terminal of the n-ch MOS transistor M433 are connected to each other. For this reason, a current (IDET−IREF) obtained by subtracting the current IREF flowing through the n-ch MOS transistor M432 from the current IDET flows through the n-ch MOS transistor M433. Accordingly, a mirror current outputted from the n-ch MOS transistor M434 also becomes the current (IDET−IREF).

Furthermore, a current mirror circuit of a mirror ratio equal to 1 formed by p-ch MOS transistors M435, M436 is connected to the n-ch MOS transistor M434, and a mirror current outputted from the p-ch MOS transistor M436 becomes an RSSI current IRSSI. To put it specifically, the RSSI current IRSSI is IRSSI=(IDET−IREF).

Meanwhile, when the lock detection signal LD indicates “L”, the amplitude detection unit 1041 is turned into a non-operation state, the RSSI current IRSSI, which corresponds to the current mirror circuit of a mirror ratio equal to 1 connected to the n-ch MOS transistor M434 becomes zero.

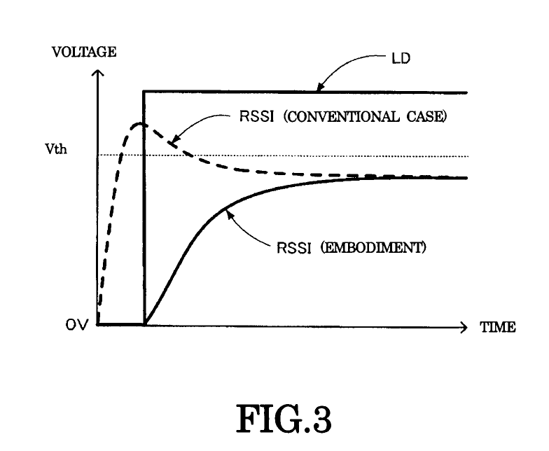

FIG. 3 shows how the RSSI signal voltage changes with respect to a change in the lock detection signal LD when the RSSI signal error-detection protection circuit 1 of the first embodiment is used. As a conventional case, FIG. 3 also shows an RSSI signal voltage waveform when the RSSI signal error-detection protection circuit 1 of the first embodiment is not used, for the purpose of comparison.

In the conventional case, the RSSI circuit operates even when the lock detection signal LD indicates “L.” Thus, there is a case where an RSSI signal voltage transiently exceeding a threshold is outputted.

In contrast to the conventional case, the RSSI signal error-detection protection circuit 1 of the first embodiment causes the RSSI circuit 104 to stop operation when the lock detection signal LD indicates “L.” Then, after the lock detection signal LD changes to “H,” the RSSI signal error-detection protection circuit 1 of the first embodiment causes the RSSI circuit 104 to start operation. In such a manner, no RSSI signal voltage exceeding the threshold is outputted while the lock detection signal LD indicates “L” i.e., while the oscillation frequency of the VCO 105 is unstable.

According to the first embodiment described above, it is possible to prevent the RSSI circuit 104 from outputting an erroneous RSSI signal while the PLL circuit 106 is in an unlocked state, which is during start-up or the like of the power supply in the case of reception channel switching or intermittent reception.

### Second Embodiment

In the first embodiment, the RSSI signal starts rising from 0V when the lock detection signal LD transitions from “L” to “H.” As a result, it takes a while until the RSSI signal converges to the final voltage and thus some time is required until the original detection operation starts. In this respect, a second embodiment shows an example of an RSSI signal error-detection protection circuit capable of reducing the time required until the RSSI signal converges to the final voltage.

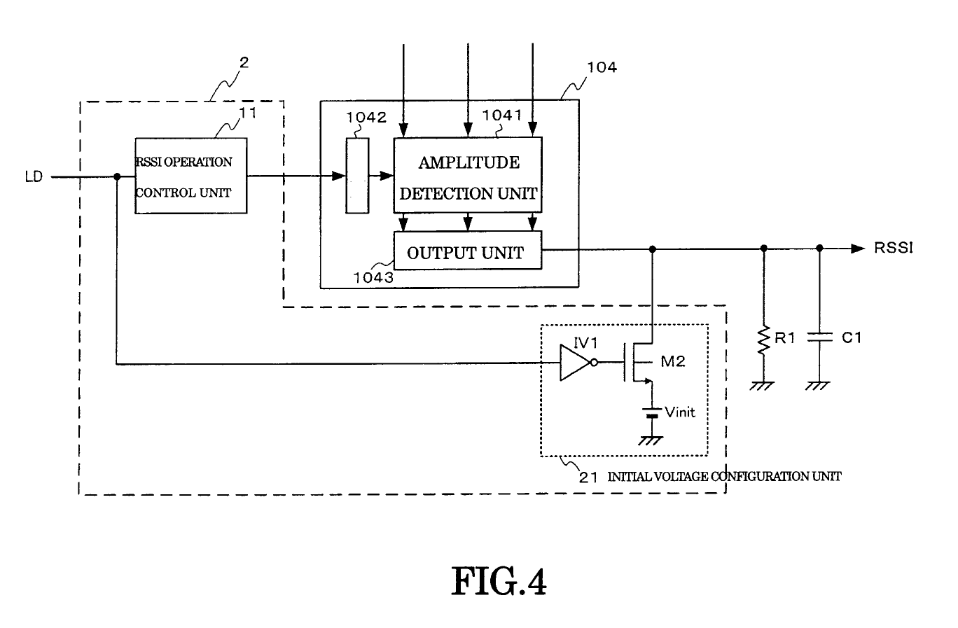

FIG. 4 is a circuit diagram showing a configuration example of an RSSI signal error-detection protection circuit 2 according to the second embodiment.

The RSSI signal error-detection protection circuit 2 of the second embodiment includes an initial voltage configuration unit 21, which configures an initial voltage of the RSSI signal, in addition to an RSSI operation control unit 11.

The initial voltage configuration unit 21 includes a voltage source Vinit, an n-ch MOS transistor M2, and an inverter IV1. The voltage source Vinit generates an initial voltage VINIT of the RSSI signal. The n-ch MOS transistor M2 is connected between an RSSI signal output terminal of an RSSI circuit 104 and the voltage source Vinit. The inverter IV1 inputs an inversion signal of the lock detection signal LD to the gate terminal of the n-ch MOS transistor M2.

The n-ch MOS transistor M2 provides the initial voltage VINIT to the RSSI signal output terminal when the lock detection signal LD indicates “L.”

Here, the initial voltage VINIT is configured.

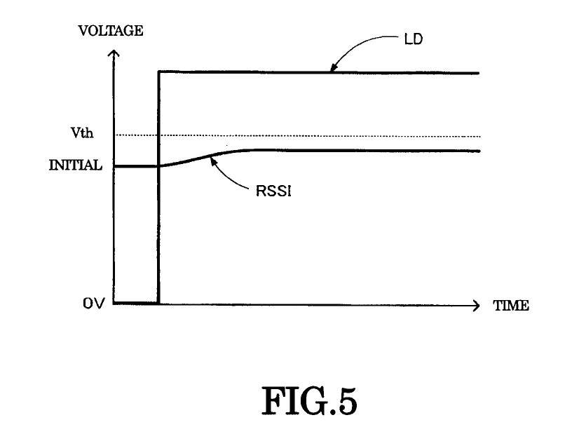

FIG. 5 shows an RSSI signal voltage with respect to the lock detection signal LD when the RSSI signal error-detection protection circuit 2 of the second embodiment is used.

In comparison with FIG. 3, it can be seen that the time required until the RSSI signal converges to the final voltage is reduced when the RSSI signal error-detection protection circuit 2 of the second embodiment is used.

According to the second embodiment described above, the time required until the RSSI signal converges to the final voltage is reduced. Thus, the time required until the RSSI circuit 104 starts the original detection operation can be reduced.

### Third Embodiment

The second embodiment shows an example in which a voltage source is used to configure the initial voltage of the RSSI signal, but a third embodiment shows an example in which a current source is used to configure the initial voltage of the RSSI signal.

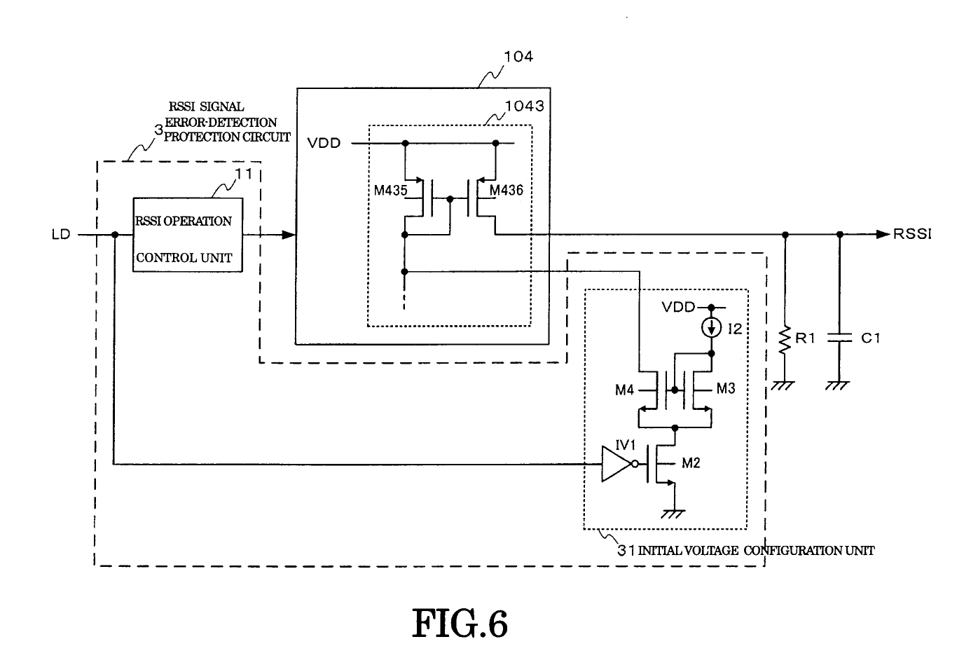

FIG. 6 is a circuit diagram showing a configuration example of an RSSI signal error-detection protection circuit 3 of the third embodiment.

The RSSI signal error-detection protection circuit 3 of the third embodiment includes an initial voltage configuration unit 31, which configures the initial voltage of the RSSI signal, in addition to an RSSI operation control unit 11.

The initial voltage configuration unit 31 includes a current source 12, an n-ch MOS transistor M3, an n-ch MOS transistor M4, an n-ch MOS transistor M2, and an inverter IV1. The n-ch MOS transistor M3 is connected to the current source 12. The n-ch MOS transistor M9 forms a current mirror circuit with the n-ch MOS transistor M3. The n-ch MOS transistor M2 is connected between the n-ch MOS transistor M3 and the n-ch MOS transistor M4, and a ground terminal VSS. The inverter IV1 inputs an inversion signal of the lock detection signal LD to the gate terminal of the n-ch MOS transistor M2.

Here, the output terminal of the n-ch MOS transistor M4 is connected to a p-ch MOS transistor M435 in an internal circuit example of an output unit 1043 of an RSSI circuit 104 shown in FIG. 2.

In the initial voltage configuration unit 31, electrical continuity is established through the n-ch MOS transistor M2 when the lock detection signal LD indicates “L” and a current flows through the n-ch MOS transistor M3 from the current source 12, and the mirror current of the n-ch MOS transistor M3 and the n-ch MOS transistor M4 is outputted from the n-ch MOS transistor M4.

The aforementioned mirror current flows through the p-ch MOS transistor M435 of the output unit 1043 of the RSSI circuit 104 to which the n-ch MOS transistor M4 is connected, and then is outputted as the RSSI current from a p-ch MOS transistor M436, which forms a current mirror circuit with the p-ch MOS transistor M435.

The RSSI current is changed to a voltage via the resistance R1 and then outputted as the initial voltage of the RSSI signal.

According to the third embodiment, the initial voltage can be provided to the RSSI signal output terminal by using the current source when the lock detection signal LD indicates “L.”

### Fourth Embodiment

In a case where a time margin needs to be provided until an RSSI circuit 104 starts operation after a PLL circuit 106 is locked, the rising of a lock detection signal LD inputted to each of the RSSI signal error-detection protection circuits 1 to 3 of the respective embodiments can be delayed.

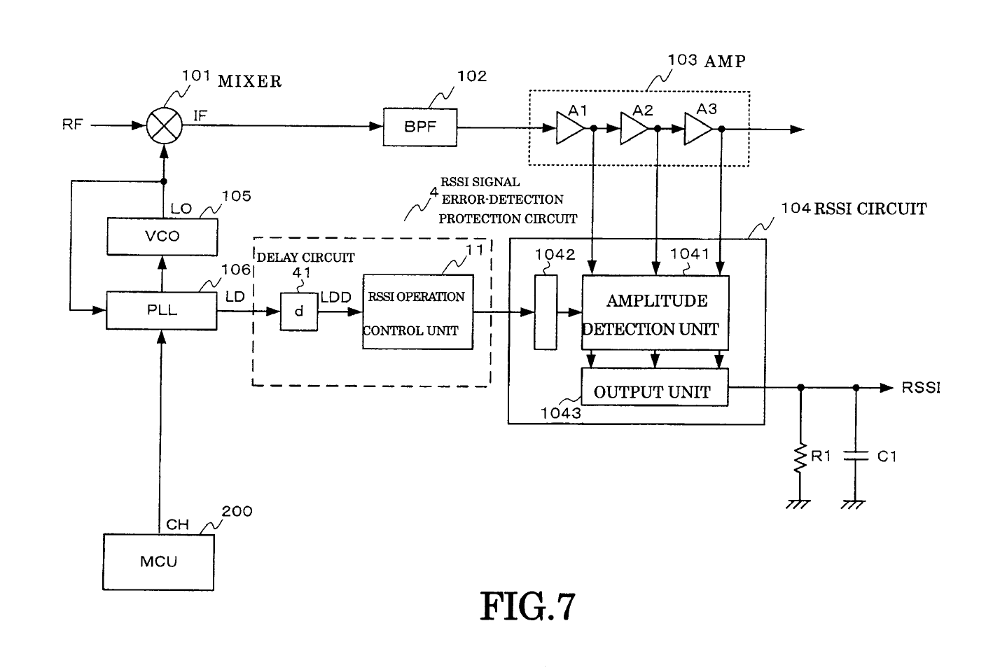

FIG. 7 is a circuit diagram showing a configuration example of an RSSI signal error-detection protection circuit 4 of a fourth embodiment.

The RSSI signal error-detection protection circuit 4 is configured by adding a delay circuit 41, which outputs a delay lock detection signal LDD by delaying a lock detection signal LD, to an RSSI signal error-detection protection circuit 1 of the first embodiment. The delay lock detection signal LDD outputted from the delay circuit 41 is inputted to an RSSI operation control unit 11.

The addition of the delay circuit 41 makes it possible to delay the start of operation of the RSSI circuit 104 with respect to the rising of the lock detection signal LD.

Meanwhile, the addition of the delay circuit 41 to the RSSI signal error-detection protection circuits 2, 3 brings about the same effect.

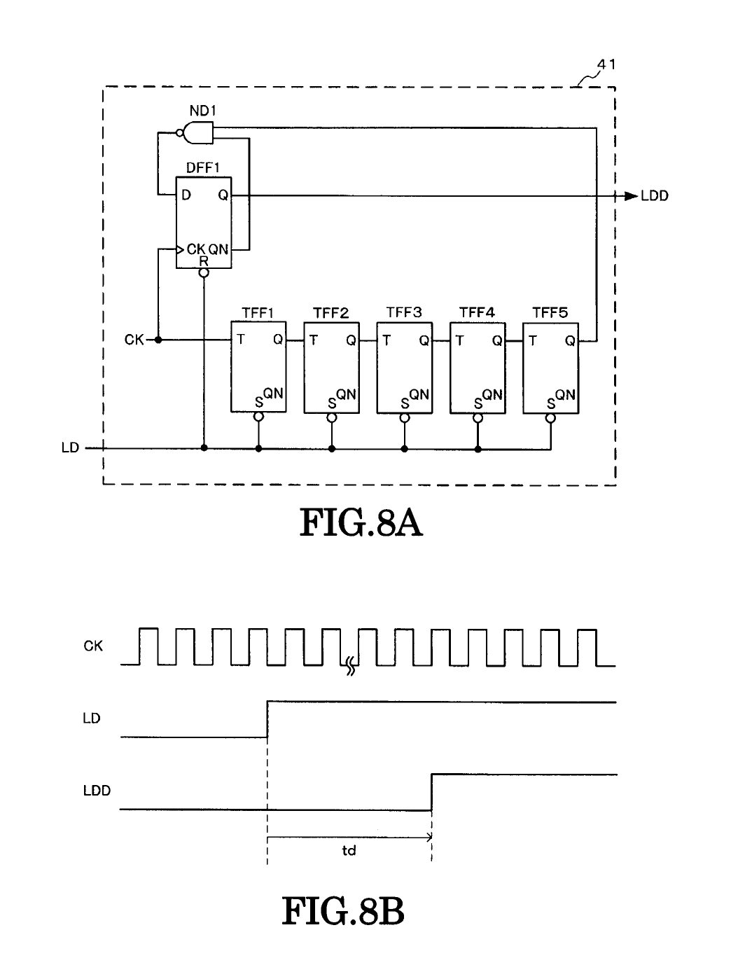

A specific circuit example of the delay circuit 41 is shown in FIG. 8A. In addition, an operation waveform example of the delay circuit 41 is shown in FIG. 8B.

In the example, a divide-by-25 frequency divider is formed by a toggle type flip-flop in five stages (TFF1-TFF5), and the rising of the lock detection signal LD is delayed by half of divide-by-25 frequency division by a D-type flip-flop DFF1 and a NAND gate ND1.

To put it specifically, when the frequency of a clock signal CK inputted to the toggle type flip-flop TFF1-TFF5 and the D-type flip-flop DFF1 is set to be a frequency fCK and a delay time td from the rising of the lock detection signal LD to the rising of the delay lock detection signal LDD is expressed as a formula, td=1/(fCK/25−1).

According to the fourth embodiment described above, the time margin can be provided until the RSSI circuit 104 starts to be operated after the PLL circuit 106 is locked.

### Application Example

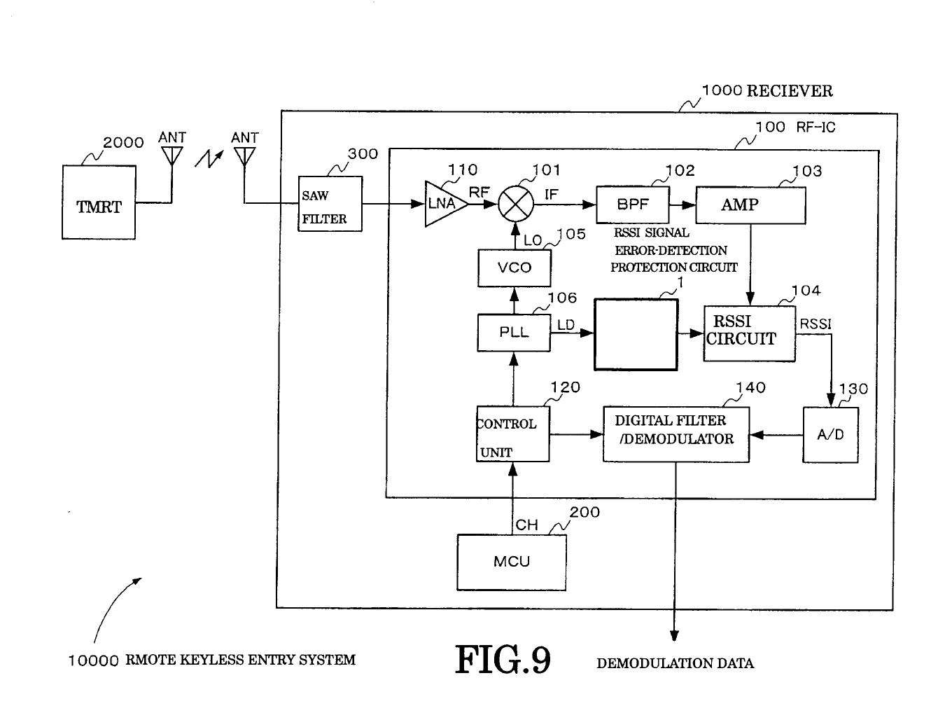

FIG. 9 is a bock diagram showing a configuration example of a remote keyless entry system which is an application example of the RSSI signal error-detection protection circuit of each of the aforementioned embodiments. Here, an example in which the RSSI signal error-detection protection circuit 1 of the first embodiment is used is shown, but the RSSI signal error-detection protection circuit of another one of the embodiments can be used.

The remote keyless entry system is configured of a receiver 1000 and a transmitter 2000.

The receiver 1000 includes an RF-IC (radio frequency receiving integrated circuit) 100, an MCU 200 and a SAW filter 300 to which a signal received by an antenna (ANT) is inputted.

The RSSI signal error-detection protection circuit 1 is installed in the RF-IC 100. In addition, the RF-IC 100 includes an LNA (low noise amplifier) 110, an A/D converter 130 and a digital filter/demodulator 140 in addition to the blocks shown in FIG. 1. The LNA 110 amplifies the output of the SAW filter 300. The RSSI signal is inputted to the A/D converter 130. The output of the A/D converter 130 is inputted to the digital filter/demodulator 140. The digital filter/demodulator 140 outputs demodulated data.

Note that, in the RF-IC 100, a control unit 120, which receives a reception channel setting instruction from the MCU 200, configures the frequency of a PLL circuit 106.

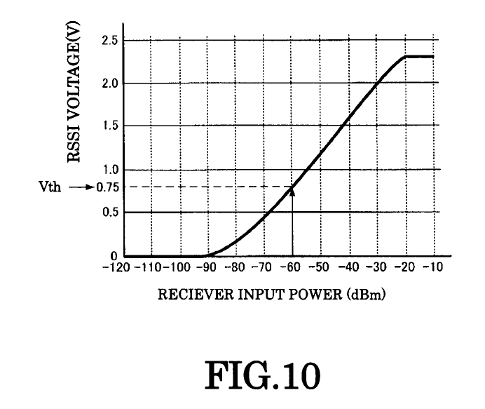

FIG. 10 is a characteristic diagram showing an example of a relation between the receiver input power and the RSSI signal output voltage in the remote keyless entry system.

Here, when a threshold voltage (determination basis of the presence/absence of a desired signal) of the input power of the receiver is set to −60 dB, the corresponding threshold voltage of the RSSI signal output voltage is 0.75V.

Since the remote keyless entry system employs the RSSI signal error-detection protection circuit 1, no RSSI signal exceeding the threshold voltage is outputted from the RSSI circuit 104 while the PLL circuit 106 is in an unlocked state, which is during the reception channel switching or the like. Thus, whether or not the receiver 1000 receives the desired signal can be correctly determined.

According to the RSSI signal error-detection protection circuit of at least one of the embodiments described above, it is possible to prevent erroneous detection of an RSSI signal when the receiver is not in a normal reception state.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An RSSI signal error-detection protection circuit configured with respect to an RSSI circuit outputting an RSSI signal on a basis of an output level of an amplifier amplifying intermediate frequency signal outputted from a mixer circuit, comprising:
an RSSI operation control unit configured to switch between operation and non-operation of the RSSI circuit by controlling the lock detection signal outputted from the PLL circuit configured to control a local oscillation frequency signal inputted from the mixer circuit.

2. The RSSI signal error-detection protection circuit of claim 1, wherein
the RSSI operation control unit includes a current source circuit configured to generate an operation current of the RSSI circuit and a first switch configured to switch whether provides or not the operation current outputted from the current source circuit to the RSSI circuit.

3. The RSSI signal error-detection protection circuit of claim 2, wherein
the first switch is constituted with a first MOS transistor.

4. The RSSI signal error-detection protection circuit of claim 2, wherein
the current source circuit includes a reference current source, a second MOS transistor connected to the reference current source, a third MOS transistor which is constituted as a current mirror circuit together with the second MOS transistor and a fourth MOS transistor in which a mirror current outputted into the third MOS transistor is configured to flow.

5. The RSSI signal error-detection protection circuit of claim 1, further comprising:
an initial voltage configuration unit configured to provide an initial voltage to an RSSI signal output terminal within a range not exceeding a detection determination threshold of the RSSI signal when the lock detection signal is indicated as an unlocked state through a second switch configured to be controlled by the lock detection signal.

6. The RSSI signal error-detection protection circuit of claim 5, wherein
the second switch is configured to switch a voltage source generating the initial voltage whether connects or not to the RSSI signal output terminal.

7. The RSSI signal error-detection protection circuit of claim 5, wherein
the lock detection signal is inputted into the second switch through an inverter as an inversion signal.

8. The RSSI signal error-detection protection circuit of claim 5, wherein
the second switch is configured to switch an output of a current source generating a current which generates the initial voltage to a resistance connected to the RSSI signal output terminal.

9. The RSSI signal error-detection protection circuit of claim 8, wherein
a current mirror circuit constituted with a fifth MOS transistor and sixth MOS transistor connect between the current source and the second switch.

10. The RSSI signal error-detection protection circuit of claim 1, further comprising:
a delay circuit configured to regulate a delay time of the lock detection signal.

11. The RSSI signal error-detection protection circuit of claim 10, wherein
the delay circuit is constituted with a frequency divider, a flip-flop and a NAND gate inputted from the divider and the flip-flop.

12. The RSSI signal error-detection protection circuit of claim 11, wherein
the delay circuit is constituted with a multistep flip-flop.

13. a receiver, comprising;
a mixer circuit;
an amplifier amplifying intermediate frequency signal outputted from a mixer circuit;
an RSSI circuit outputting an RSSI signal on a basis of the output level outputted from the amplifier;
a PLL circuit configured to control a frequency of a local oscillation frequency inputted to the mixer circuit; and
an RSSI signal error-detection protection circuit which includes an RSSI operation control unit configured to switch between operation and non-operation of the RSSI circuit by controlling the lock detection signal outputted from the PLL circuit.

14. the receiver of claim 13, wherein
the RSSI operation control unit includes a current source circuit configured to generate an operation current of the RSSI circuit and a first switch configured to switch whether provides or not the operation current outputted from the current source circuit to the RSSI circuit.

15. the receiver of claim 13, wherein
the RSSI signal error-detection protection circuit further includes an initial voltage configuration unit configured to provide an initial voltage to an RSSI signal output terminal within a range not exceeding a detection determination threshold of the RSSI signal when the lock detection signal is indicated as an unlocked state through a second switch configured to be controlled by the lock detection signal.

16. the receiver of claim 13, wherein
the RSSI signal error-detection protection circuit further includes a delay circuit which configured to regulate a delay time of the lock detection signal.

17. a remote keyless entry system, comprising;
a transmitter; and
a receiver, the receiver being constituted with a radio frequency receiving integrated circuit, an MCU, and a SAW filter inputted a signal received by an antenna, the radio frequency receiving integrated circuit being constituted with a mixer circuit, an amplifier amplifying intermediate frequency signal outputted from a mixer circuit, an RSSI circuit outputting an RSSI signal on a basis of the output level outputted from the amplifier, a PLL circuit configured to control a frequency of a local oscillation frequency inputted from the mixer circuit, and an RSSI signal error-detection protection circuit which includes an RSSI operation control unit configured to switch between operation and non-operation of the RSSI circuit by controlling the lock detection signal outputted from the PLL circuit.

18. The remote keyless entry system of claim 17, wherein
the RSSI operation control unit includes a current source circuit configured to generate an operation current of the RSSI circuit and a first switch configured to switch whether provides or not the operation current outputted from the current source circuit to the RSSI circuit.

19. The remote keyless entry system of claim 17, wherein
the RSSI operation control unit includes a current source circuit configured to generate an operation current of the RSSI circuit and a first switch configured to switch whether provides or not the operation current outputted from the current source circuit to the RSSI circuit.

20. The remote keyless entry system of claim 17, wherein
the RSSI signal error-detection protection circuit further includes a delay circuit configured to regulate a delay time of the lock detection signal.
